(19) United States
(12) Patent Application Publication
(10) Pub. No.: US 2013/0157042 A1
(43) Pub. Date: Jun. 20, 2013

(54) ELECTRICALLY INSULATING MATERIAL, INSULATING PAPER, AND INSULATING TAPE FOR A HIGH VOLTAGE ROTARY MACHINE

(71) Applicants: Mario Brockschmidt, Oberhausen (DE); Peter Gröppel, Erlangen (DE); Friedhelm Pohlmann, Essen (DE)

(72) Inventors: Mario Brockschmidt, Oberhausen (DE); Peter Gröppel, Erlangen (DE); Friedhelm Pohlmann, Essen (DE)

(21) Appl. No.: 13/696,665

(22) PCT Filed: Apr. 20, 2011
(86) PCT No.: PCT/EP2011/056375

§ 371 Date: Jan. 9, 2013

(30) Foreign Application Priority Data
May 7, 2010 (DE) 10 2010 019 721.1

(51) Int. Cl. B32B 27/20; H01B 3/02

(52) U.S. Cl. CPC B32B 27/20; H01B 3/025
USPC 428/329; 524/437

(57) ABSTRACT

An electrical insulation material for a high-voltage rotary machine includes a base resin and a filler powder distributed as the sole filler in the base resin, the powder being formed of disc-like particles of aluminum oxide. An insulation paper for a high-voltage rotary machine includes the electrical insulation material. An insulation tape for a high-voltage rotary machine includes a carrier strip and a strip of insulation paper that is applied and attached to the carrier strip.

### CROSS REFERENCE TO RELATED APPLICATIONS

This application is the US National Stage of International Application No. PCT/EP2011/056375, filed Apr. 20, 2011 and claims the benefit thereof. The International Application claims the benefits of German application No. 10 2010 019 721.1 DE filed May 7, 2010. All of the applications are incorporated by reference herein in their entirety.

### FIELD OF INVENTION

The invention relates to an electrically insulating material for a high voltage rotary machine, an insulating paper, which is manufactured from the insulating material and an insulating tape, which is manufacturing from the insulating paper. The electrically insulating material, the insulating paper and the insulating tape are suitable for electrical insulation in a high voltage rotary machine.

### BACKGROUND OF INVENTION

For a high voltage rotary machine, such as for instance a turbo generator in a power plant for generating electrical energy, a high degree of efficiency and a high availability are required. A high mechanical, thermal and electrical strain on the components of the turbo generator generally results therefrom. The turbo generator comprises in particular a stator winding, on which particularly high demands are made in respect of stability and reliability. In particular, the insulating system of the stator winding on the boundary surface between the main insulation and the laminated core of the stator winding is under significant stress due to a high thermal, thermomechanical, dynamic and electromechanical operational stress as a result of which the risk of damage to the insulating system of the stator winding is high on account of partial discharges, which occur incessantly during operation of the high voltage rotary machine. With the insulating system electrical conductors (wires, coils, rods, subconductors) are permanently insulated against one another and against a stator laminated core or the surroundings. A distinction is made within a high voltage insulation between subconductors (subconductor insulation), between the conductors and/or windings (conductor and/or winding insulation) and between conductors and ground potential in the groove and winding head area (main insulation). The operational reliability of the high voltage rotary machine governs the reliability of the insulating system.

One problem with the insulating system is that on account of the strong electrical load of the insulating material of the insulating system, the latter is exposed to a partial discharge-induced erosion. In this way “treeing” channels form in the insulating material, which may result in an electrical breakdown of the insulating material. The propagation of “treeing” channels in the insulating material is knowingly intentionally prevented by adding mica, for instance in the form of mica paper, to the insulating material. When producing mica paper, mica particles with an aspect ratio of at least 50 are used, i.e. the ratio of length to width on the one hand and the mica particle width on the other is at least 50. The mica particles herewith form a large surface, wherein the mica particles are aligned with one another. The mica paper is as result elastically bendable and mechanically resilient. Binding forces result here on account of an interaction by van der Waals forces or hydrogen bridging bonds between the surfaces of the mica particles, which are determined by the size of contact surfaces of adjacent mica particles. The mica paper is thus flexible and can therefore be wound for instance about an electrical conductor. The mica paper can also be impregnated by means of a reaction resin, and consequently represent a good barrier for “treeing” channels.

The mica particles are exposed to partial discharges, so that it is desirable for the mica particles to have a high partial discharge resistance. This is provided on account of the organic structure of the mica particles. In order to improve the mechanical stability of the mica paper, this is applied to a carrier made of glass or polyester fabric, whereby the mica paper forms a composite material. This is produced by the mica paper being impregnated and hardened by means of a liquid and reactive polymer. The mica paper in strip form forms a mica tape.

It is known to manufacture a corona protection tape as a fabric with the mica tape for instance, wherein the mica tape is secured on the fabric with an adhesive. The insulation system comprises the corona protection tape, with which electrical conductors are to be electrically insulated in the high voltage rotary machine. The thermal conductivity of the mica tape conventionally impregnated with epoxy resin with glass or polyester fabric as the carrier material amounts to approx. 0.2-0.25 W/mK at room temperature. On account of this thermal conductivity of the corona protection tape, which can be classified as minimal, the heat formed in the conductor during operation of the high voltage rotary machine can be given off to the corona protection tape only to a minor extent. A heat build-up on the corona protection tape takes place during operation of the high voltage rotary machine. The stators of the larger generators are therefore cooled by means of hydrogen or water for instance. Reducing the thickness of the corona protection tape may assist, as a result of which the efficiency and the electrical degree of efficiency of the high voltage rotary machine could be increased.

To further increase the thermal conductivity of the corona protection tape, it is known to additionally provide thermally conductive particles, such as for instance bromine nitride or diamond, in the corona protection tape. Since these materials, on account of their dimensions and their physical properties, have almost no positive effect on the electrical stability of the insulating system, it is imperative for the corona protection tape to be mixed with the mica. The proportion of additional particles and the mica in the insulating system is adjusted such that the proportion of the mica is high such that the thermal conductivity of the corona protection tape is sufficiently high and the proportion of the additional particles is low such that the resulting electrical stability of the corona protection tape is adequately high. With a conventional corona protection tape having additional boron nitride particles, a maximum thermal conductivity of 0.5 W/mK can be achieved at room temperature. It is disadvantageous here that the layer thickness of the corona protection tape is high and that the boron nitride particles perpendicular to the corona protection tape have a lower thermal conductivity than in the longitudinal direction of the corona protection tape. The thermal conductivity of the corona protection tape is as a result disadvantageously anisotropic, as a result of which the use of this corona protection tape is restricted.

### SUMMARY OF INVENTION

The object of the invention is to create an electrical insulating material for a high voltage rotary machine, an insulating paper, which is manufactured from the insulating material and an insulating tape which is manufactured from the insulating paper, wherein the electrical insulation of the high voltage rotary machine is effective.

The inventive electrical insulating material for a high voltage rotary machine has a base resin and a filler powder distributed in the base resin as the sole filler, which is formed of disc-shaped particles made of aluminum oxide. The proportion of the filler power preferably lies between 50% by vol and 75% by vol, wherein the proportion of the filler powder more preferably lies at 70% by vol. It is also preferred that the filler powder exists in particle sizes in the range of 0.002μ and 150μ. Here the filler powder preferably lies in a monomodal, bimodal or multimodal distribution.

The inventive insulating paper for a high voltage rotary machine has the electrical insulating material. The inventive insulating tape for a high voltage rotary machine has a carrier tape and a tape of an insulating paper, wherein the tape of the insulating paper is applied to and secured on the carrier tape. It is preferred that the tape of the insulating paper is glued to the carrier tape.

The sole filler in the base resin is formed of disc-shaped aluminum oxide particles, with which, on account of their special form, the electrical stability of the insulating material is high. Furthermore, the thermal conductivity of the insulating material due to the provision of solely the disc-shaped aluminum oxide particles, since the intrinsic conductivity of aluminum oxide lies at 25 to 40 W/mK, whereupon conventional mica has a value of 1 W/mK. As a result, the inventive provision of the disc-shaped aluminum oxide particles in the insulating material enables the inventive insulating material to manage without the conventional mica additive. Furthermore, the insulating basic material can be processed to form an insulating paper, which can be processed according to the invention to form an insulating tape which can be advantageously used in a high voltage rotary machine for electrical insulation. The proportion of disc-shaped aluminum oxide particles in the base resin preferably amounts to up to 70% by vol, without in the process the mechanical and electrical properties of the insulating material being impaired. The higher the volume fill level of the disc-shaped aluminum oxide particles in the base resin, the higher the resulting thermal conductivity of the insulating material. With a volume fill level of 50% by vol of disc-shaped aluminum oxide particles in the base resin, a thermal conductivity of 0.8 W/mK for the insulating material results.

In addition, on account of the planar embodiment of the disc-shaped aluminum oxide particles in the base resin, it is possible to simply form the insulating tape in a planar manner with the insulating paper, which is manufactured from the insulating material. As a result, a rewinding of conductors of the high voltage rotary machine is advantageously possible with the insulating tape, wherein the insulating tape can also be subjected to an impregnation, in particular a thorough impregnation. Furthermore, the insulating material has a high stability with respect to the formation of “treeing” channels in the insulating paper, as a result of which high volume fill levels of the disc-shaped aluminum oxide particles are advantageously enabled in the base resin. As a result, the insulating material has a high thermal conductivity. On account of the anorganic structure of the disc-shaped aluminum oxide particles in the base resin, the insulating material has a high temperature stability.

### DETAILED DESCRIPTION OF INVENTION

The invention is described in more detail below with the aid of an example.

An electrical insulating material for a high voltage rotary machine is formed from a base resin. A filler powder is provided in the base resin as the sole filler, which is arranged in the base resin in as evenly distributed a manner as possible. Another filler in particle form is not provided in the base resin. The filler is a filler powder, which is formed from disc-shaped particles made of aluminum oxide.

The proportion of the filler powder in the base resin lies between 50% by vol and 75% by vol, preferably at 70% by vol. The filler powder exists in particle sizes in the range of 0.002μ to 150μ. Furthermore, the filler powder exists in a monomodal, bimodal or multimodal distribution.

An insulating paper for a high voltage rotary machine is manufactured with the electrical insulating material. In addition, an insulating tape for a high voltage rotary machine is manufactured using the insulating paper. The insulating tape has a carrier tape and a tape of the insulating paper. The tape of the insulating paper is applied to and secured on the carrier tape, wherein the tape of the insulating paper is glued to the carrier tape.

1-7. (canceled)

8. An electrical insulating material for a high voltage rotary machine, comprising:
a base resin, and
a filler powder distributed in the base resin as the sole filler and formed of disc-shaped particles made of aluminum oxide.

9. The electrical insulating material as claimed in claim 8, wherein the proportion of the filler powder lies between 50% by vol and 75% by vol.

10. The electrical insulating material as claimed in claim 9, wherein the proportion of the filler powder is at 70% by vol.

11. The electrical insulating material as claimed in claim 8, wherein the filler powder exists in particle sizes in the range of 0.0002μ to 150μ.

12. The electrical insulating material as claimed in claim 8, wherein the filler powder exists in a monomodal, bimodal or multimodal distribution.

13. An insulating paper for a high voltage rotary machine, comprising:
an electrical insulating material as claimed in claim 8.

14. An insulating tape for a high voltage rotary machine, comprising:
a carrier tape, and
a tape of an insulating paper as claimed in claim 13, wherein the tape of the insulating paper is applied to and secured on the carrier tape.

15. The insulating tape as claimed in claim 14, wherein the tape of the insulating paper is glued to the carrier tape.
